(19) United States
(12) Patent Application Publication
(10) Pub. No.: US 2014/0074681 A1
(43) Pub. Date: Mar. 13, 2014

(54) SYSTEM AND METHOD FOR TRADING GREEN TECHNOLOGY AND PATENT TECHNOLOGY

(71) Applicant: Gil Sun KIM, Seoul (KR)

(72) Inventor: Gil Sun KIM, Seoul (KR)

(21) Appl. No.: 13/706,823

(22) Filed: Dec. 6, 2012

(30) Foreign Application Priority Data
Sep. 10, 2012 (KR) 10-2012-0099829

(51) Int. Cl. G06Q 40/04

(52) U.S. Cl. CPC G06Q 40/04; G06Q 50/184
USPC 705/37

(57) ABSTRACT

A system and method for trading green technology and patent technology. The system includes a patent owner computer for entrusting purchase of a certain patent right to a patent trading market, a patent exchange server for evaluating a value of the patent right as in a stock exchange market, deciding a price of the patent right, deciding how many pieces the patent right will be divided into, and publishing the decided details of the patent right. An examination authority server receives information from an expert group evaluating and examining a value of the patent right registered in the patent exchange server and entrusted by the patent exchange server, and providing results of the evaluation and examination with respect to the patent right to the patent exchange server. A patent purchaser computer participates in purchasing of the patent right, and a patent infringement monitoring server monitors patent infringement.

### BACKGROUND OF THE INVENTION

1. Field of the Invention

The present invention relates to a system and method for trading green technology and patent technology for green technology and patent technology promotion, and more particularly to a system and method for trading green technology and patent technology wherein the value of a certain patent right is decided at a patent trading market, the price of the patent right is decided based on the value of the patent right so that the entirety of the patent right can be traded, and the patent right is divided into N pieces so that shares of the patent right can be traded.

2. Description of the Related Art

Green technology is an environmentally friendly technology of utilizing resources, such as regenerated and clean energy resources. Specifically, the green technology is a technology that is capable of saving and efficiently using energy and resources throughout overall processes of social and economic activities, thereby minimizing discharge of greenhouse gas and pollutants. For example, the green technology may include greenhouse gas reduction technology, energy efficiency improvement technology, clean production technology, clean energy technology, resource circulation technology, and an environmentally friendly technology (including related fused technologies).

Generally, green technology and patent technology have been traded simply in a one-to-one transaction fashion. Furthermore, unverified patents have been traded. As a result, huge damage and waste of funds have been caused in a related industry. On the other hand, a large number of excellent patents have gone unused without commercialization due to lack of funds. This is a frequent occurrence. Also, a considerable number of patent owners have not been aware of the fact that their patents had been infringed upon with the result that they have suffered losses. This is also a frequent occurrence.

### SUMMARY OF THE INVENTION

Therefore, the present invention has been made in view of the above problems, and it is an object of the present invention to provide a system and method for trading green technology and patent technology wherein technology, such as green technology or patent technology (including patents, utility models, trademarks, and designs) is evaluated at a patent trading market like a stock exchange market to decide the value and price of the right so that the entirety or some of the right can be traded, thereby contributing to industrial development through commercialization of excellent patent technologies, and patent infringement is quickly recognized so that a patent owner can cope with such patent infringement.

In accordance with an aspect of the present invention, the above and other objects can be accomplished by the provision of a patent technology trading system for patent technology promotion including:

a patent owner computer for entrusting purchase of a certain patent right to a patent trading market to trade the entirety of the certain patent right or shares of the patent right,

a patent exchange server, at which the patent trading market is formed, for evaluating a value of the patent right as in a stock exchange market, deciding a price of the patent right, deciding how many pieces the patent right will be divided into, and publishing the decided details of the patent right through the Internet or an electronic bulletin board of the patent exchange server,

an examination authority server, registered in the patent exchange server, for receiving information from an expert group, such as patent attorneys and patent lawyers, evaluating and examining a value of the patent right registered in the patent exchange server and entrusted by the patent exchange server, and providing results of the evaluation and examination with respect to the patent right to the patent exchange server,

a patent purchaser computer for participating in purchase of the patent right according to the price published by the patent exchange server, and

a patent infringement monitoring server for monitoring patent infringement and a security system for security, wherein the patent infringement monitoring server comprises at least one selected from among a plurality of mobile phones, laptop personal computers (PCs), tablet PCs, and personal digital assistants (PDAs) for collecting evidence of patent infringement,

a patent trading application is installed in the patent owner computer, the patent exchange server, the examination authority server, the patent purchaser computer, the mobile phones, the laptop PCs, the tablet PCs, and the PDAs,

upon receiving a request for infringement monitoring with respect to a certain patent from the patent exchange server, the patent infringement monitoring server acquires information regarding the patent, accesses the patent trading application, inputs information regarding the patent, such as a patent application number and the invention title of the patent, executes the patent trading application, and instructs one selected from among a plurality of mobile phones registered in the patent infringement monitoring server on the grounds that the selected mobile phone is proper to perform infringement monitoring with respect to the requested patent to monitor whether the requested patent has been infringed upon, and the mobile phones selected for infringement monitoring access the patent trading application through input of identifications (IDs) and passwords, set information regarding the mobile phones, such as current locations and desired conditions of the mobile phones, and transmit the set information to the patent infringement monitoring server,

the patent infringement monitoring server receives the information and instructs one of the mobiles phone satisfying conditions to secure evidence of infringement, and the mobile phone collects evidence, for example acquires pictures of products infringing upon the patent right or specification on transaction and transmits evidence data to the patent infringement monitoring server in a case in which the evidence has been secured, and

the patent infringement monitoring server verifies the data received from the mobile phone and transmits the verification result to the patent exchange server, the patent exchange server acquires the evidence, determines whether the evidence will be accepted, and transmits determination as to whether the evidence has been accepted to the patent infringement monitoring server, the patent infringement monitoring server informs the mobile phone of the determination as to whether the evidence has been accepted, and, upon determining that the evidence has been accepted, the mobile phone receives a prize according to an appropriated schedule table, thereby performing patent infringement monitoring.

In accordance with another aspect of the present invention, there is provided a patent technology trading method for patent technology promotion including:

a patent owner entrusting a patent exchange server with selling of a patent right owned by the patent owner using a patent owner computer through the Internet, and the patent exchange server retrieving the patent right of the client, i.e. the patent owner, to confirm the patent right of the client, requesting an examination authority server registered in the patent exchange server to evaluate the entrusted patent right, evaluating a value of the patent right and deciding a price of the patent right based on the evaluation of the examination authority server, deciding how many pieces the patent right will be divided into, and publishing the decided details of the patent right through the Internet or an electronic bulletin board of the patent exchange server, and

in a case in which patent infringement monitoring is requested by the patent owner, the patent exchange server acquiring pictures or videos of products infringing upon the patent right through mobile phones registered in the patent exchange server and, upon determining that the patent has not been infringed upon, performing patent transaction so that patent purchaser computers participate in transaction, and, when the patent owner sells shares of the patent right and makes a profit as the result of commercialization of the patent, the patent exchange server paying dividends proportional to a share rate of the patent, wherein

upon receiving a request for infringement monitoring with respect to a certain patent from the patent exchange server, a patent infringement monitoring server acquires information regarding the patent, accesses a patent trading application, inputs information regarding the patent, such as a patent application number and the invention title of the patent, executes the patent trading application, and instructs one selected from among a plurality of mobile phones registered in the patent infringement monitoring server on the grounds that the selected mobile phone is proper to perform infringement monitoring with respect to the requested patent to monitor whether the requested patent has been infringed upon, and the mobile phones selected for infringement monitoring access the patent trading application through input of identifications (IDs) and passwords, set information regarding the mobile phones, such as current locations and desired conditions of the mobile phones, and transmit the set information to the patent infringement monitoring server,

the patent infringement monitoring server receives the information and instructs one of the mobiles phone satisfying conditions to secure evidence of infringement, and the mobile phone collects evidence, for example acquires pictures of products infringing upon the patent right or specification on transaction and transmits evidence data to the patent infringement monitoring server in a case in which the evidence has been secured, and

the patent infringement monitoring server verifies the data received from the mobile phone and transmits the verification result to the patent exchange server, the patent exchange server acquires the evidence, determines whether the evidence will be accepted, and transmits determination as to whether the evidence has been accepted to the patent infringement monitoring server, the patent infringement monitoring server informs the mobile phone of the determination as to whether the evidence has been accepted, and, upon determining that the evidence has been accepted, the mobile phone receives a prize according to an appropriated schedule table, thereby performing patent infringement monitoring.

According to the present invention, inventors can raise funds necessary to commercialize a patent technology from a patent trading market, and therefore, it is possible for the inventors to flexibly secure funds and to put the patent technology to practical use. Also, it is possible for the inventors to confirm whether patent infringement has occurred through a general mobile application, and therefore, it is not necessary for the inventors to make efforts in monitoring patent infringement. Consequently, it is possible to promote protection of patent technology.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing a patent technology trading system according to an embodiment of the present invention;

FIG. 2 is a flow chart showing a patent technology trading method according to an embodiment of the present invention; and

FIG. 3 is a flow chart showing the patent technology trading method according to the embodiment of the present invention.

### DETAILED DESCRIPTION OF THE INVENTION

Now, a patent technology trading system and method according to an embodiment of the present invention will be described in detail with reference to the accompanying drawings.

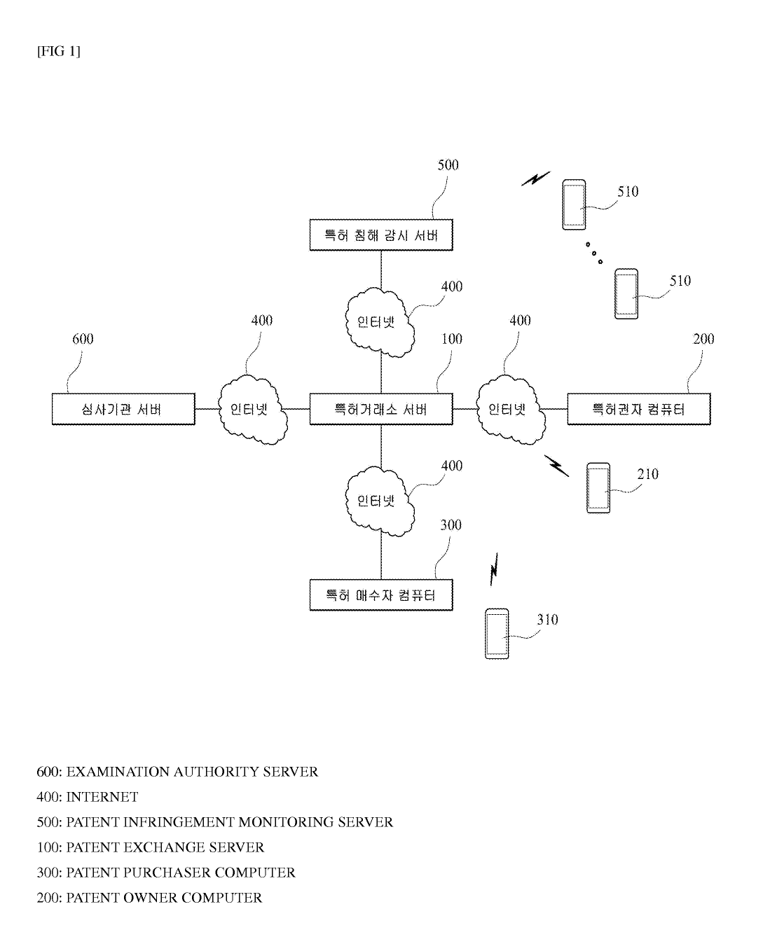

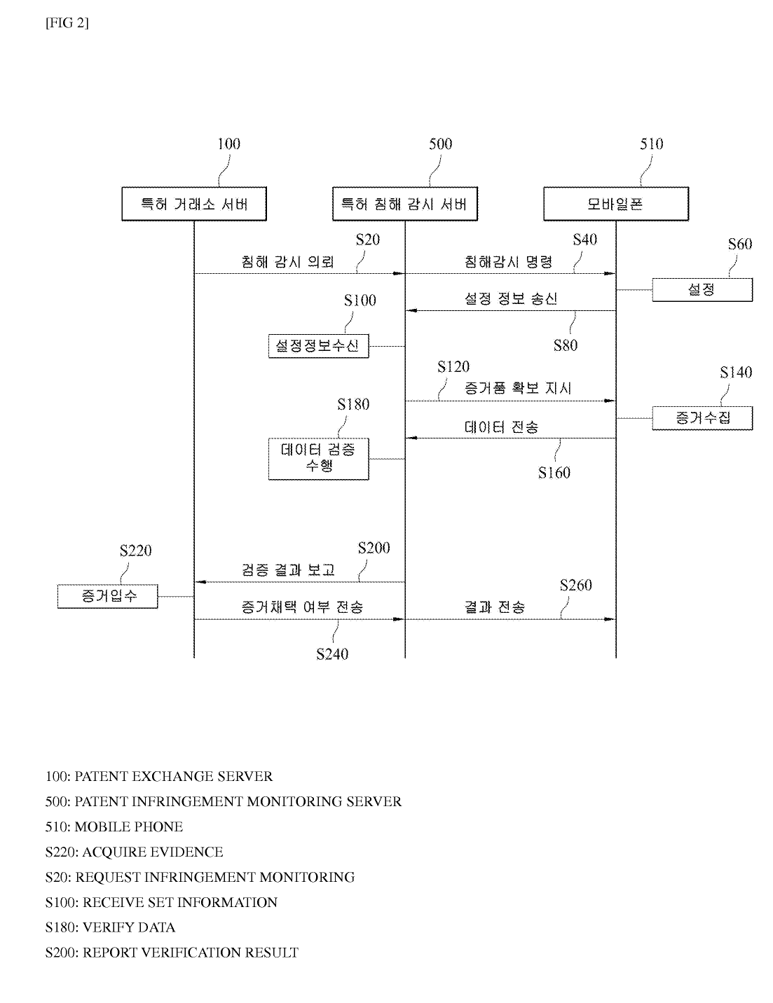

FIG. 1 is a block diagram showing a patent technology trading system according to an embodiment of the present invention.

As shown in FIG. 1, the patent technology trading system according to the embodiment of the present invention includes a patent exchange server 100, a patent owner computer 200, a patent purchaser computer 300, the Internet 400, a patent infringement monitoring server 500, and an examination authority server 600 registered in the patent exchange server. Also, the patent technology trading system includes mobile phones 210, 310, and 510. The mobile phones may be smartphones. However, the smartphones are merely an example of the mobile phones, and therefore, any devices that are capable of performing functions equivalent to those of the smartphones may be used. For example, laptop personal computers (PCs), tablet PCs such as iPad, and personal digital assistants (PDAs) may be used as the mobile phones. However, the mobile phones are not limited thereto.

The patent exchange server 100 is a place at which a patent trading market is formed. The patent exchange server 100 evaluates values of patent rights as securities as in a stock exchange market. Also, the patent exchange server 100 may receive information regarding whether a patent right is valid and patent contents from a site such as the Institute of Patent Information based on information regarding the patent right provided from the patent owner computer 200. In a case in which it is not possible for the patent exchange server 100 to receive patent contents from the site such as the Institute of Patent Information, the patent exchange server 100 may directly receive data from a patent owner.

The patent exchange server 100 evaluates a value of a patent provided from the patent owner computer 200 and decides a price of the patent based thereupon. Evaluation of the value of the patent right and decision of the price of the patent right are performed by collecting data from the examination authority server 600 that receives information from an expert group, such as patent attorneys, patent lawyers, and related industrial specialists, and provides results of the evaluation and examination with respect to the patent right and referring to prices of similar patent rights formed in a patent trading market. The expert group is paid predetermined money for the evaluation of the value of the patent right.

Also, the patent exchange server 100 sets a value of the provided patent right and decides how many pieces the patent right will be divided into based on the set value. How many pieces the patent right will be divided into may be decided based on a predetermined criterion according to the value evaluated with respect to the patent right. The predetermined criterion may be the number of claims of the patent right or whether the price of the patent right is high or low, which, however, is merely an example. Any criteria may be used so long as the criteria are fair.

When the value of the patent right provided from the patent owner computer 200 is evaluated, the price of the patent right is decided, and shares are decided, the patent exchange server 100 may publish the decided details of the patent right through an electronic bulletin board (not shown) of the patent exchange server or the Internet.

Transmission and reception of data to and from the respective devices are performed through the Internet 400. As shown in FIG. 1, transmission and reception of data between the respective devices may be possible through wireless communication, such as wireless fidelity (WiFi), third generation (3G), and long term evolution (LTE), using the mobile phones 210, 310, and 510, which may be smartphones, as well as the computer. As previously described, however, the mobile phones are not limited thereto, and any devices that are capable of performing functions identical or similar to those of the smartphones may be used. It is necessary to install a patent trading application, which is applied to the present invention, developed by the applicant of the present application in the patent exchange server 100, the patent owner computer 200, and the mobile phones 210, 310, and 510.

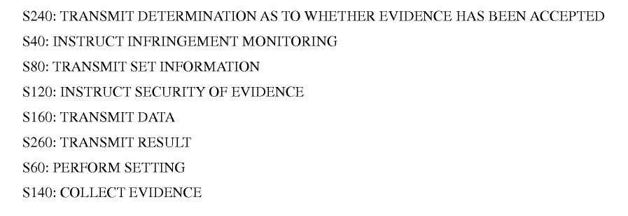

FIG. 2 is a flow chart showing a patent infringement monitoring process realized in the patent technology trading system according to the embodiment of the present invention.

Hereinafter, a patent infringement monitoring process realized by the patent trading application of the present invention will be described in detail.

First, upon receiving a request for infringement monitoring with respect to a certain patent from the patent exchange server 100, the patent infringement monitoring server 500 acquires information regarding the patent, accesses the patent trading application, inputs information regarding the patent, such as a patent application number and the invention title of the patent, executes the patent trading application, and instructs one, e.g. one mobile phone 510, selected from among a plurality of mobile phones 510 registered in the patent infringement monitoring server 500 on the grounds that the selected mobile phone 510 is proper to perform infringement monitoring with respect to the requested patent to monitor whether the requested patent has been infringed upon (S20 and S40).

The mobile phones 510 access the patent trading application through input of identifications (IDs) and passwords, set information regarding the mobile phones, such as current locations and desired conditions of the mobile phones, and transmit the set information to the patent infringement monitoring server 500 (S60 and S80). The patent infringement monitoring server 500 receives the information and instructs one of the mobile phones 510 satisfying conditions to secure evidence of infringement (S100 and S120).

Subsequently, the mobile phone 510 collects evidence, for example acquires pictures of products infringing upon the patent right or specification on transaction (S140), and transmits evidence data to the patent infringement monitoring server 500 in a case in which the evidence has been secured (S160). In a case in which no evidence has been secured, however, the mobile phone 510 does not transmit any data to the patent infringement monitoring server 500.

Subsequently, the patent infringement monitoring server 500 verifies the data received from the mobile phone 510 and transmits the verification result to the patent exchange server 100 (S180 and S200). Subsequently, the patent exchange server 100 acquires the evidence, determines whether the evidence will be accepted, and transmits determination as to whether the evidence has been accepted to the patent infringement monitoring server 500. The patent infringement monitoring server 500 informs the mobile phone 510 of the determination as to whether the evidence has been accepted. Upon determining that the evidence has been accepted, the mobile phone 510 may receive a prize according to an appropriated schedule table.

Referring back to FIG. 1, when the patent exchange server 100 publishes the patent right which has been provided from the patent owner computer 200, and the value of which has been evaluated, the price of which has been decided, and shares of which have been decided by the examination authority server 600 through the Internet, a plurality of patent purchasers may participate in transaction through their computers 300 or their mobile phones 310 so that the patent right can be traded in an auction fashion or a stock market fashion.

When the transaction is completed, and the patent owner who has a license of the partially sold patent right makes a profit as the result of commercialization, the patent purchasers who have shares of the patent right may be paid dividends within a range of shares of the patent right from the patent exchange server 100 through their computers 300.

The price of the patent right may be set based on rise and fall in price of the patent right according to the result of patent right enforcement as in stocks.

Of course, it is necessary for the patent exchange server 100 to have a security system that is capable of sufficiently protecting the patent exchange server 100 from attack of hackers.

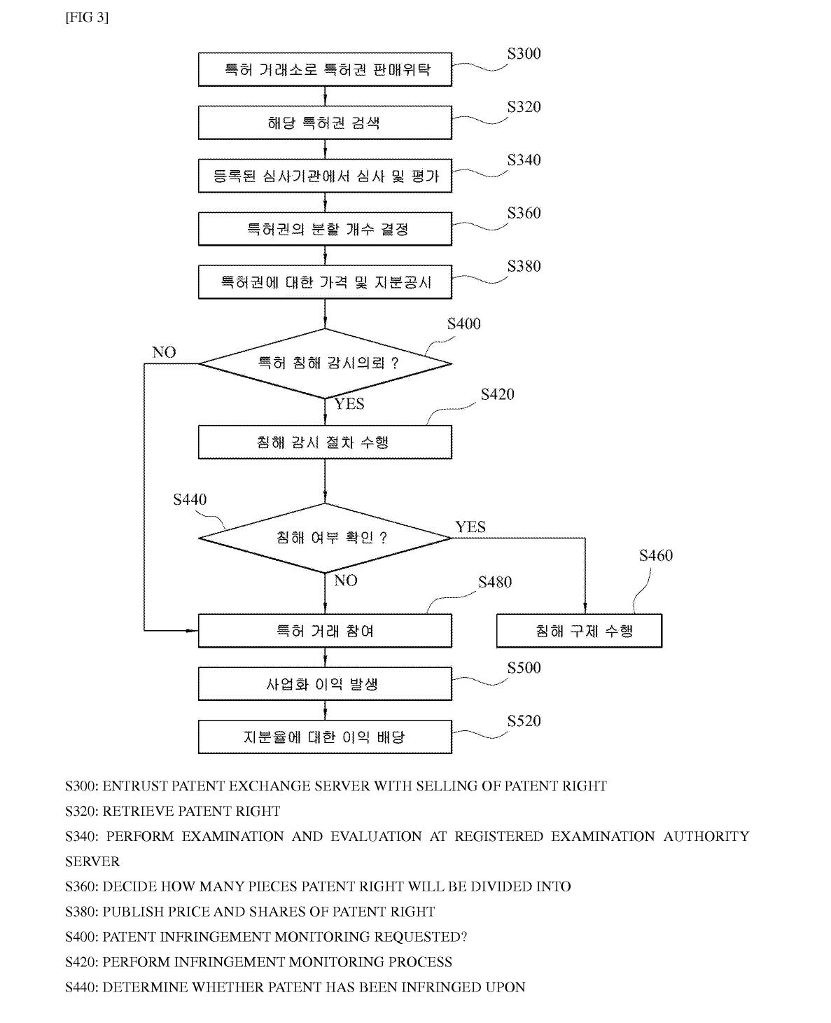

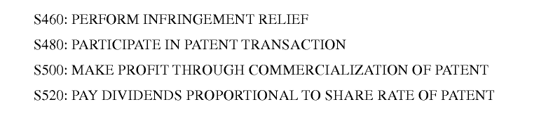

FIG. 3 is a flow chart showing the patent technology trading method according to the embodiment of the present invention.

First, the patent owner entrusts the patent exchange server 100 with selling of a patent right owned by the patent owner using the patent owner computer 200 through the Internet 400, and the patent exchange server 100 retrieves the patent right of the client, i.e. the patent owner, to confirm the patent right of the client (S300 and S320). Subsequently, the patent exchange server 100 request the examination authority server 600 registered in the patent exchange server 100 to evaluate the entrusted patent right, and evaluates a value of the patent right and decides a price of the patent right based on the evaluation of the examination authority server 600, decides how many pieces the patent right will be divided into based on the evaluated value of the patent right or the number of claims of the patent right (S340 and S360), and publishes the decided details of the patent right through the electronic bulletin board of the patent exchange server or the Internet (S380).

Meanwhile, in a case in which patent infringement monitoring is requested by the patent owner (S400), the infringement monitoring process as shown in FIG. 2 is performed (S420), and it is determined whether the patent has been infringed upon (S440). Upon determining that the patent has been infringed upon, infringement relief is performed without patent transaction (S460).

In a case in which patent infringement monitoring is not requested by the patent owner, however, the infringement monitoring process is not performed.

Upon determining that the patent has not been infringed upon, patent transaction is performed. In this case, the patent purchaser computers 300 may participate in transaction (S480). Participation in transaction may be performed in an auction fashion or a stock market fashion. When the patent owner sells shares of the patent right and makes a profit as the result of commercialization of the patent, the patent exchange server 100 pays dividends proportional to a share rate of the patent (S500 and S520). In a case in which the entirety of the patent right has been sold, distribution of profit does not occur.

In the above, the patent technology trading system according to the embodiment of the present invention was described based on patent transaction. Alternatively, the patent technology trading system according to the embodiment of the present invention may be applied to green technology. Also, the patent technology trading system according to the embodiment of the present invention may be applied to immaterial property rights, such as a copyright and a sound source.

As is apparent from the above description, the patent technology trading system and method with the above-stated construction according to the embodiment of the present invention has the following effects. Inventors can raise funds necessary to commercialize patent technology from a patent trading market, and therefore, it is possible for the inventors to flexibly secure funds and to put the patent technology to practical use. Also, it is possible for the inventors to confirm whether patent infringement has occurred through a general mobile application, and therefore, it is not necessary for the inventors to make efforts in monitoring patent infringement. Consequently, it is possible to promote protection of patent technology.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A patent trading system, comprising:
a patent owner computer for entrusting purchase of a patent right to a patent trading market in order to sell the patent right or shares of the patent right;
a patent exchange server, at which the patent trading market is formed, for:
(a) deciding a value of the patent right and a price of the patent right,
(b) deciding how many pieces the patent right will be divided into, and
(c) publishing the decided details of the patent right on an electronic bulletin board of the patent exchange server through the Internet;
an examination authority server, connected to the patent exchange server, for:
(a) receiving information about the patent right entrusted from the patent exchange server, from an expert group, such as patent attorneys or patent lawyers,
(b) evaluating a value of the patent right entrusted from the patent exchange server, and
(c) providing a result of the evaluation with respect to the value of patent right to the patent exchange server;
a patent purchaser computer for participating in purchase of the patent right according to the price published by the patent exchange server; and
a patent infringement monitoring unit for monitoring patent infringement;
wherein, the patent infringement monitoring unit comprises a patent infringement monitoring server and at least one device selected from the group consisting of a mobile phones, a laptop personal computers (PCs), a tablet PCs, and a personal digital assistants (PDAs) for collecting evidence data of patent infringement,
and wherein, a patent trading application is installed in the patent owner computer, the patent exchange server, the examination authority server, the patent purchaser computer, and the at least one device,
and wherein, if the patent infringe monitoring server receives a request for infringement monitoring with respect to the patent right from the patent exchange server,
(a) the patent infringement monitoring server instructs the at least one device via the patent trading application to perform infringe monitoring,
(b) one or more of the at least one device transmit information comprising a location, and a desired reward via the patent trading application to the patent infringement monitoring server, and
(c) based on the information from one or more of the at least one device, the patent infringement monitoring server instructs one or more of the at least one device via the patent trading application to collect evidence data of infringement,
(d) one or more of the at least one device transmits evidence data to the patent infringement monitoring server via the patent trading application,
(e) the patent infringement monitoring server verifies the evidence data from one or more of the at least one device and transmits the verification result to the patent exchange server via the patent trading application,
(f) the patent exchange server determines whether the evidence data is accepted or not, and transmits result of the determination to the patent infringement monitoring server via the patent trading application,
(g) the patent infringement monitoring server informs one or more of the at least one device of the result of the determination via the patent trading application and transmits the desired reward to a user of the one or more of the at least one device if the evidence of data of the user is accepted.

2. (canceled)

3. The patent technology trading system according to claim 1, wherein how many pieces the patent right will be divided into is decided based on a predetermined criterion, such as the number of claims of the patent right or the price of the patent right.

4. The patent technology trading system according to claim 1, wherein communication between the patent infringement monitoring server and the at least one device is performed through wireless communication, such as wireless fidelity (WiFi), third generation (3G), and long term evolution (LTE).

5-7. (canceled)
